(19) United States
(12) Patent Application Publication
(10) Pub. No.: US 2026/0012343 A1
(43) Pub. Date: Jan. 8, 2026

(54) COMMUNICATION METHOD, APPARATUS, AND DEVICE, AND NON-VOLATILE READABLE STORAGE MEDIUM

(71) Applicant: IEIT SYSTEMS (Beijing) Co., Ltd., Beijing (CN)

(72) Inventors: Dongdong SU, Beijing (CN); Yanmei SHEN, Beijing (CN); Wei LIU, Beijing (CN); Yanwei WANG, Beijing (CN); Rengang LI, Beijing (CN)

(73) Assignee: IEIT SYSTEMS (Beijing) Co., Ltd., Beijing (CN)

(21) Appl. No.: 19/131,099

(22) PCT Filed: May 29, 2023
(86) PCT No.: PCT/CN2023/096877

§ 371 Date: May 19, 2025

(30) Foreign Application Priority Data
Nov. 18, 2022 (CN) 202211448097.3

(51) Int. Cl. H04L 9/14; H04L 9/08

(52) U.S. Cl. CPC H04L 9/14; H04L 9/0816

(57) ABSTRACT

Disclosed are a communication method, apparatus, and device, and a non-volatile readable storage medium, which relate to the technical field of data security. The communication method includes: a key corresponding to current time is computed according to initial keys, where the initial keys include at least one first initial key and a second initial key; a data message is generated according to the key and to-be-transmitted data; the data message is transmitted to a message receiving end; a verification data message is generated according to verification keys, where the verification keys include at last one first verification key and a second verification key; and the verification data message is transmitted to the message receiving end, and validity of the data message is caused to be verified by the message receiving end according to the initial keys and the verification data message.

### CROSS-REFERENCE TO RELATED APPLICATION

The disclosure claims the benefit of priority to Chinese Patent Application No. 202211448097.3, filed with the Chinese Patent Office on Nov. 18, 2022 and entitled “Communication method, apparatus, and device, and computer-readable storage medium”, which is incorporated herein in its entirety by reference.

### TECHNICAL FIELD

The disclosure relates to the technical field of data security, particularly relates to a communication method, and further relates to a communication apparatus and device and a non-volatile readable storage medium.

### BACKGROUND

In recent years, numerous manufacturers have successively launched a novel computing method taking a cluster of field programmable gate array (FPGA) accelerators interconnected by a network as main computing power. A large number of FPGA accelerators are mounted by a specially-made low-energy consumption server which has a peripheral component interconnect express (PCIe) power supply capacity but is not assisted by a central processing unit (CPU). The network is connected by a router. Fewer servers are required because the FPGA accelerators and servers are unbound. Only a small quantity of servers are used for computing task allocation, security management, etc. of the FPGA accelerators. However, when the cluster of FPGA accelerators are interconnected by the network, security of the cluster of FPGA accelerators becomes an urgent problem to be resolved due to limitation of simple architectures of the FPGA accelerators.

The existing security solution for the FPGA cluster tends to construct a key-based (a key is generally generated through symmetric encryption or asymmetric encryption) security system between the servers and the FPGA accelerators to guarantee the security of the FPGA cluster. However, this method has two security risks as below. 1. Since a limited number of servers are arranged, when FPGA accelerators are added to the cluster of FPGA accelerators, keys will be frequently established between the servers and the FPGA accelerators, resulting in network congestion and security degradation. If this problem is resolved by adding servers, energy consumption will be increased, and other problems may occur. 2. No corresponding secure communication mechanism is constructed in the cluster of FPGA accelerators, so data communication between the FPGA accelerators will suffer from various network attacks such as distributed denial of service (DDOS).

Thus, how to guarantee secure communication between FPGA accelerators while secure communication between servers and the FPGA accelerators is guaranteed has become an urgent technical problem to be resolved by a person skilled in the art.

### SUMMARY

An objective of the disclosure is to provide a communication method. Another objective of the disclosure is to provide a communication apparatus and device, and a non-volatile readable storage medium.

The disclosure provides a communication method. The communication method includes:
a key corresponding to current time is computed according to initial keys, where the initial keys include at least one first initial key and a second initial key, the at least one first initial key is generated by a server, and the second initial key is generated by an encryption dedicated FPGA accelerator;
a data message is generated according to the key and to-be-transmitted data;
the data message is transmitted to a message receiving end;
a verification data message is generated according to verification keys, where the verification keys include at last one first verification key and a second verification key, the first verification key at last one is obtained by searching the server, and the second verification key is obtained by searching the encryption dedicated FPGA accelerator; and
the verification data message is transmitted to the message receiving end, and validity of the data message is caused to be verified by the message receiving end according to the initial keys and the verification data message.

In some embodiments, the at least one first initial key includes: a first-level initial key and a second-level initial key. The first-level initial key is generated by the server for the encryption dedicated FPGA accelerator and forwarded by the encryption dedicated FPGA accelerator to a computation dedicated FPGA accelerator in an interconnected FPGA accelerator cluster corresponding to the encryption dedicated FPGA accelerator. The second-level initial key is generated by the server for the computation dedicated FPGA accelerator and broadcasted to the computation dedicated FPGA accelerator.

In some embodiments, a method through which the key generated by the server for the encryption dedicated FPGA is forwarded by the encryption dedicated FPGA accelerator includes:

the key generated by the server for the encryption dedicated FPGA accelerator is transmitted, by the encryption dedicated FPGA accelerator through an inter-core data transmission channel, to the computation dedicated FPGA accelerator interconnected to the encryption dedicated FPGA accelerator; and the received key is forwarded, by the computation dedicated FPGA accelerator interconnected to the encryption dedicated FPGA accelerator, to other computation dedicated FPGA accelerators in a same router.

In some embodiments, keys generated by the server for different encryption dedicated FPGA accelerators are different.

In some embodiments, the at last one first verification key includes: a first-level verification key and a second-level verification key. A first-level verification key is computed by the server according to the first-level initial key. A second-level verification key is computed by the server according to the second-level initial key.

In some embodiments, the data message and the verification data message are transmitted to the message receiving end in parallel.

In some embodiments, the validity of the data message is caused to be verified according to the initial keys and the verification data message as follows:
the verification data message is parsed, and the verification keys are obtained;
to-be-verified keys are computed according to the initial keys;
the verification keys are compared with the to-be-verified keys;
the data message is not received in a case that the verification keys are different from the to-be-verified keys;
the validity of the data message is verified according to the verification keys in a case that the verification keys are the same as the to-be-verified keys;
the data message is received in a case that the validity passes verification; and
the data message is not received in a case that the validity does not pass the verification.

In some embodiments, a time interval for updating a second-level key chain by the server is greater than a time interval for updating a first-level key chain by the server and less than a time interval for updating a key chain by the encryption dedicated FPGA accelerator. The first-level key chain is a key chain generated by the server for the encryption dedicated FPGA accelerator. The second-level key chain is a key chain generated by the server for the computation dedicated FPGA accelerator.

In some embodiments, the time interval for updating the first-level key chain by the server, the time interval for updating the second-level key chain by the server, and the time interval for updating the key chain by the encryption dedicated FPGA accelerator satisfy:

$$Δ2 = {n}_{1} * Δ1 ;$$

$$and$$

$$Δ3 = {n}_{2} * Δ2 ;$$

where

Δ1 denotes the time interval for updating the first-level key chain by the server, n₁ denotes a number of keys in the first-level key chain, Δ2 denotes the time interval for updating the second-level key chain by the server, n₂ denotes a number of keys in the second-level key chain, and Δ3 denotes the time interval for updating the key chain by the encryption dedicated FPGA accelerator.

In some embodiments, the step that a key corresponding to current time is computed according to the initial keys includes:
a time serial number corresponding to the current time is computed according to the current time, initial time, and a time interval for updating a key chain; and
the key corresponding to the current time is computed according to the time serial number and the initial keys.

In some embodiments, the step that a time serial number corresponding to the current time is computed according to the current time, initial time, and a time interval for updating a key chain includes:
time serial number corresponding to the current time is computed according to

$$j = \frac{{T}_{now} - {T}_{0}}{Δ} mod n ;$$

where
j denotes the time serial number, T_{now} denotes the current time, T₀ denotes the initial time, Δ denotes the time interval for updating the key chain, and n denotes a number of keys in the key chain.

In some embodiments, the step that the key corresponding to the current time is computed according to the time serial number and the initial keys includes: the key corresponding to the current time is computed according to Sⱼ=S^{j}(S₀); where

Sⱼ denotes the key corresponding to the current time, j denotes the time serial number, and S₀ denotes the initial keys.

In order to resolve the above technical problems, the disclosure provides a communication apparatus. The communication apparatus includes:
a computing module configured to compute a key corresponding to current time according to initial keys, where the initial keys include at least one first initial key and a second initial key, the at least one first initial key is generated by a server, and the second initial key is generated by an encryption dedicated FPGA accelerator;
a first message generating module configured to generate a data message according to the key and to-be-transmitted data;
a first message transmitting module configured to transmit the data message to a message receiving end;
a second message generating module configured to generate a verification data message according to verification keys, where the verification keys include at last one first verification key and a second verification key, the at last one first verification key is obtained by searching the server, and the second verification key is obtained by searching the encryption dedicated FPGA accelerator; and
a second message transmitting module configured to transmit the verification data message to the message receiving end, and cause validity of the data message to be verified by the message receiving end according to the initial keys and the verification data message.

In order to resolve the above technical problems, the disclosure provides a communication device. The communication device includes:
a memory configured to store a computer program; and
a processor configured to implement steps of any one of the above communication methods when executing the computer program.

In order to resolve the above technical problems, the disclosure provides a non-volatile readable storage medium. The non-volatile readable storage medium stores a computer program, where the computer program is configured to implement steps of any one of the above communication methods when executed by a processor.

A communication method provided in the disclosure includes: a key corresponding to current time is computed according to initial keys, where the initial keys include at least one first initial key and a second initial key, the at least one first initial key is generated by a server, and the second initial key is generated by an encryption dedicated FPGA accelerator; a data message is generated according to the key and to-be-transmitted data; the data message is transmitted to a message receiving end; a verification data message is generated according to verification keys, where the verification keys include at last one first verification key and a second verification key, the at last one first verification key is obtained by searching the server, and the second verification key is obtained by searching the encryption dedicated FPGA accelerator; and the verification data message is transmitted to the message receiving end, and validity of the data message is caused to be verified by the message receiving end according to the initial keys and the verification data message.

### BRIEF DESCRIPTION OF THE DRAWINGS

In order to describe technical solutions in examples of the disclosure more clearly, accompanying drawings required to be used in the prior art and in the examples will be briefly introduced below. Clearly, the accompanying drawings in the following descriptions show merely some examples of the disclosure. A person of ordinary skill in the art can derive other accompanying drawings according to these accompanying drawings without making creative efforts.

FIG. 1 is a flowchart of a communication method according to an example of the disclosure;

FIG. 2 is a schematic diagram of a field programmable gate array (FPGA) accelerator cluster network according to an example of the disclosure;

FIG. 3 is a schematic diagram of a key chain according to an example of the disclosure;

FIG. 4 is a schematic diagram of a process for configuring initial keys according to an example of the disclosure;

FIG. 5 is a communication flow according to an example of the disclosure;

FIG. 6 is a schematic diagram of a communication apparatus according to an example of the disclosure; and

FIG. 7 is a schematic diagram of a communication device according to an example of the disclosure.

### DETAILED DESCRIPTION OF THE EMBODIMENTS

A core of the disclosure is to provide a communication method, which can guarantee secure communication between field programmable gate array (FPGA) accelerators while secure communication between servers and the FPGA accelerators is guaranteed, can enormously improve data security, and is applicable to various network scenarios. Another core of the disclosure is to provide a communication apparatus and device, and a non-volatile readable storage medium, which have the above technical effects.

In order to make objectives, technical solutions, and advantages of examples of the disclosure clearer, technical solutions of examples of the disclosure will be clearly and completely described below in combination with accompanying drawings in the examples of the disclosure. Clearly, the described examples are some examples rather than all examples of the disclosure. All other examples derived by a person of ordinary skill in the art based on examples of the disclosure without making creative efforts all fall within the scope of protection of the disclosure.

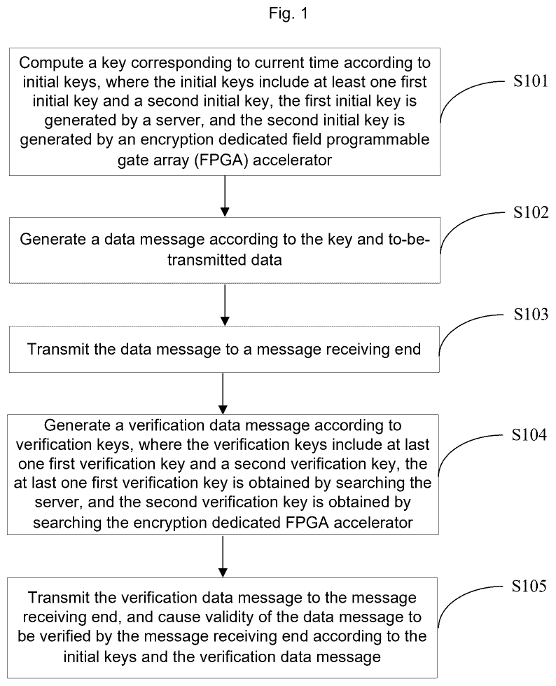

With regard to FIG. 1, a flowchart of a communication method according to an example of the disclosure is shown in FIG. 1. As shown in FIG. 1, the method mainly includes:
S101: a key corresponding to current time is computed according to initial keys, where the initial keys include at least one first initial key and a second initial key, the first initial key is generated by a server, and the second initial key is generated by an encryption dedicated FPGA accelerator;
S102: a data message is generated according to the key and to-be-transmitted data;
S103: the data message is transmitted to a message receiving end;
S104: a verification data message is generated according to verification keys, where the verification keys include at last one first verification key and a second verification key, the first verification key is obtained by searching the server, and the second verification key is obtained by searching the encryption dedicated FPGA accelerator; and
S105: the verification data message is transmitted to the message receiving end, and validity of the data message is caused to be verified by the message receiving end according to the initial keys and the verification data message.

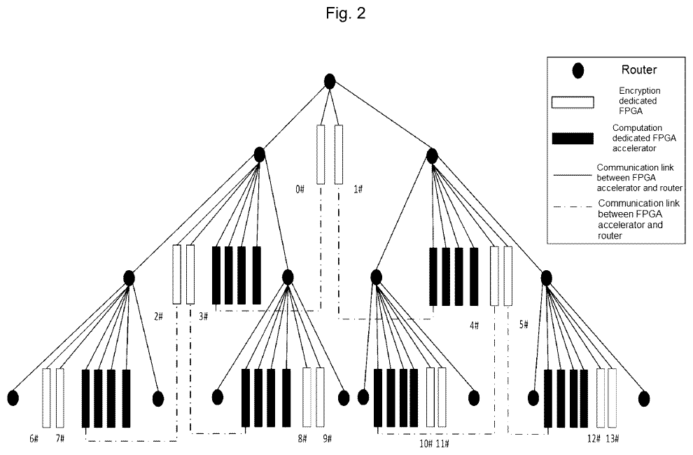

The communication method provided in the example is applied to an FPGA accelerator cluster network based on a tree topology. The FPGA accelerator cluster network based on a tree topology mainly includes the server, the encryption dedicated FPGA accelerator, a computation dedicated FPGA accelerator, and a router. For instance, with reference to FIG. 2, an FPGA accelerator cluster network based on a tree topology and having a depth of 4 is shown. In the FPGA accelerator cluster network, an interconnected FPGA accelerator cluster of an encryption dedicated FPGA accelerator is formed by a computation dedicated FPGA accelerator interconnected to the encryption dedicated FPGA accelerator and other computation dedicated FPGA accelerators belonging to the same router as the computation dedicated FPGA accelerator.

Functions of a server mainly include: 1. Information of an encryption dedicated FPGA accelerator and information of a computation dedicated FPGA accelerator in an interconnected FPGA accelerator cluster corresponding to the encryption dedicated FPGA accelerator are collected and recorded. 2. A key chain is generated and transmitted by using a pseudorandom function. 3. A message is generated and transmitted.

In order to avoid a situation that a key chain generated by a server is decrypted due to data leakage of the server, ensure security of data transmission, and enhance a difficulty of decrypting the key chain, a key chain will be generated by each encryption dedicated FPGA accelerator by using a pseudorandom function in the example. The key chain generated by the encryption dedicated FPGA accelerator will be updated to the server and a computation dedicated FPGA accelerator in an interconnected FPGA accelerator cluster corresponding to the encryption dedicated FPGA accelerator.

A function of the computation dedicated FPGA accelerator includes: a message is generated and transmitted.

That is, a message transmitter in the FPGA accelerator cluster network may be a server. In this case, a message receiver is a computation dedicated FPGA accelerator. In the FPGA accelerator cluster network, a message transmitter may be a computation dedicated FPGA accelerator. In this case, a message receiver is a computation dedicated FPGA accelerator or a server.

In a case that the message transmitter is the server, that is, in a case that an execution body of the communication method is the server, a method through which a message is transmitted by the server is as follows:
a key corresponding to current time is computed by the server according to initial keys, where the initial keys include at least one first initial key and a second initial key, the first initial key is generated by the server, and the second initial key is generated by the encryption dedicated FPGA accelerator; a data message is generated by the server according to a key and to-be-transmitted data and transmitted to a corresponding computation dedicated FPGA accelerator; a verification data message is generated by the server according to verification keys, where the verification keys include at last one first verification key and a second verification key, the first verification key is obtained by searching the server itself, and the second verification key is obtained by searching the encryption dedicated FPGA accelerator; and the verification data message is transmitted by the server to the corresponding computation dedicated FPGA accelerator, and validity of the data message is caused to be verified by the computation dedicated FPGA accelerator according to the initial keys and the verification data message.

The first verification key is the same as a key computed according to the first initial key. The second verification key is the same as a key computed according to the second initial key.

The first verification key and the second verification key may be computed by the message transmitter itself according to the initial keys, or may be acquired by the message transmitter from elsewhere.

For instance, in a case that the message transmitter is the server, the first verification key is a key computed by the server according to the first initial key. The second verification key is a key acquired by the server from the encryption dedicated FPGA accelerator and is a key corresponding to the current time computed by the encryption dedicated FPGA accelerator according to the second initial key.

In a case that the message transmitter is the computation dedicated FPGA accelerator, the first verification key is a key acquired by the computation dedicated FPGA accelerator from the server and is a key corresponding to the current time computed by the server according to the first initial key. The second verification key is a key acquired by the computation dedicated FPGA accelerator from the encryption dedicated FPGA accelerator and is a key corresponding to the current time computed by the encryption dedicated FPGA accelerator according to the second initial key.

Specifically, in an initialization phase of the FPGA accelerator cluster network, each encryption dedicated FPGA accelerator is responsible for uploading information of the encryption dedicated FPGA accelerator and information of the interconnected FPGA accelerator cluster corresponding to the encryption dedicated FPGA accelerator to the server. Each piece of the uploaded information of the encryption dedicated FPGA accelerator and information of the corresponding interconnected FPGA accelerator cluster may include information such as a serial number identity document (ID), an internet protocol (IP) address, and a media access control (mac) address.

The information uploaded by the encryption dedicated FPGA accelerator is received and stored by the server. A key chain is generated by using a pseudorandom function. In addition, key chains are generated for the corresponding interconnected FPGA accelerator cluster and the server by each encryption dedicated FPGA accelerator by using a pseudorandom function.

After a key is generated, related parameters such as the initial keys, a time interval for updating the key chain, and a number of keys included in the key chain are stored into the server and the corresponding FPGA accelerator by the server. The initialization phase ends.

When the message is transmitted by the server, on the one hand, a key corresponding to current time is computed by the server according to an initial key. The initial keys include at least one first initial key generated by the server and a second initial key generated by the encryption dedicated FPGA accelerator. Thus, the key corresponding to the current time is computed by the server according to the first initial key generated by the server. The key corresponding to the current time is computed by the server according to the second initial key generated by the encryption dedicated FPGA accelerator.

The step that a key corresponding to current time is computed according to initial keys may include:
a time serial number corresponding to the current time is computed according to the current time, initial time, and a time interval for updating a key chain; and the key corresponding to the current time is computed according to the time serial number and the initial keys.

A relationship among the current time, the initial time, the time interval for updating the key chain, and the time serial number may be as follows:

$$j = \frac{{T}_{now} - {T}_{0}}{Δ} mod n ;$$

Specifically, j denotes the time serial number, T_{now} denotes the current time, T₀ denotes the initial time, Δ denotes the time interval for updating the key chain, and n denotes a number of keys in the key chain.

A relationship among the time serial number, the initial keys, and the key corresponding to the current time may be as follows:

S=S^{j}(S₀). Specifically, Sⱼ denotes the key corresponding to the current time, j denotes the time serial number, and S₀ denotes the initial keys.

Based on that each key is computed, a data message is formed from the to-be-transmitted data and the key by the server by using a message authentication code (MAC) function, and is transmitted to a corresponding computation dedicated FPGA accelerator.

On the other hand, the server searches the encryption dedicated FPGA accelerator for the second verification key corresponding to the time serial number. A found second to-be-verified key and at last one first verification key found from the server itself are combined into a verification data message. The verification data message is transmitted to a corresponding computation dedicated FPGA accelerator. Validity of the data message is verified by using the initial keys and the verification data message which are generated by the server and the encryption dedicated FPGA accelerator and received by the computation dedicated FPGA accelerator.

In some examples, the data message and the verification data message are transmitted to a message receiving end in parallel. If the message transmitter is the server, the data message and the verification data message are transmitted by the server to the corresponding computation dedicated FPGA accelerator in parallel. Thus, efficiency and security of data authentication can be effectively improved.

In addition, in some examples, the validity of the data message is caused to be verified according to the initial keys and the verification data message as follows:
the verification data message is parsed, and the verification keys are obtained;
to-be-verified keys are computed according to the initial keys;
the verification keys are compared with the to-be-verified keys;
the data message is not received in a case that the verification keys are different from the to-be-verified keys;
the validity of the data message is verified according to the verification keys in a case that the verification keys are the same as the to-be-verified keys;
the data message is received in a case that the validity passes verification; and
the data message is not received in a case that the validity does not pass the verification.

Specifically, after the data message and the verification data message transmitted by the server are received by the computation dedicated FPGA accelerator, the verification data message is first parsed, and the verification keys are obtained. Then, to-be-verified keys are computed by the computation dedicated FPGA accelerator according to the initial keys. The computed to-be-verified keys are compared with the verification keys obtained through parsing. If a comparison result shows that the keys are the same, network security passes verification. On the contrary, if the comparison result shows that the keys are different, the network security does not pass the verification. Network security of the computation dedicated FPGA accelerator has a hidden danger. In a case that the network security does not pass the verification, the data message is not received by the computation dedicated FPGA accelerator. In a case that the network security passes the verification, the validity of the data message is verified, that is, whether data in the data message is normal is verified by the computation dedicated FPGA accelerator by further using the verification keys obtained through parsing. If the network security passes the verification, it represents that normal data can be obtained, and the data message is received by the computation dedicated FPGA accelerator. Otherwise, the data message is not received by the computation dedicated FPGA accelerator.

Based on the above examples, in order to further improve security of data communication and reduce a difficulty of decrypting a single key chain, in some examples, the first initial key includes: a first-level initial key and a second-level initial key. The first-level initial key is generated by the server for the encryption dedicated FPGA accelerator and forwarded by the encryption dedicated FPGA accelerator to a computation dedicated FPGA accelerator in an interconnected FPGA accelerator cluster corresponding to the encryption dedicated FPGA accelerator. The second-level initial key is generated by the server for the computation dedicated FPGA accelerator and broadcasted to the computation dedicated FPGA accelerator.

In the example, a two-level key chain is generated by the server. A first-level key chain is a key chain generated by the server for each encryption dedicated FPGA accelerator and an interconnected FPGA accelerator cluster corresponding to the encryption dedicated FPGA accelerator. Thus, data encryption authentication for each encryption dedicated FPGA accelerator and an interconnected FPGA accelerator cluster corresponding to the encryption dedicated FPGA accelerator can be implemented. Since a number of encryption dedicated

FPGA accelerators in the FPGA accelerator cluster network is much less than that of computation dedicated FPGA accelerators, fewer network resources such as a bandwidth are occupied when the generated key chain is transmitted by the server for each encryption dedicated FPGA accelerator.

A second-level key chain is a key chain generated by the server for the computation dedicated FPGA accelerator and is used for supplementary authentication when data is forwarded by the computation dedicated FPGA accelerator. Since the second-level key chain is distributed by the server for the computation dedicated FPGA accelerator, a number of times of distribution of a router in the FPGA accelerator cluster network is more, and more bandwidths are occupied.

Specifically, first-level key chain

$$< {S}_{1 , {n}_{1}}^{i} >$$

is generated by the server by using a pseudorandom function Sⁱ1. First-level key chain

$$< {S}_{1 , {n}_{1}}^{i} >$$

is distributed to an encryption dedicated FPGA accelerator (a serial number of the encryption dedicated FPGA accelerator is i). A time interval for updating the first-level key chain is marked as Δ1, and n₁ keys exist in total.

The received first-level key chain is distributed by encryption dedicated FPGA accelerator i to a computation dedicated FPGA accelerators in a corresponding interconnected FPGA accelerator cluster.

Second-level key chain <S_{2,n}_{₂}> is generated by the server by using pseudorandom function S₂. Second-level key chain <S_{2,n}_{₂}> is distributed in a broadcast manner to the computation dedicated FPGA accelerator in the FPGA accelerator cluster network. A time interval for updating the second-level key chain is marked as Δ2, and n₂ keys exist in total.

By generating a key by using the first-level key chain and the second-level key chain cooperatively, security of data communication can be further improved.

In order to improve data security, in some examples, keys generated by the server for different encryption dedicated FPGA accelerators are different.

Specifically, different key chains are generated for different encryption dedicated FPGA accelerators by the server by using different pseudorandom functions.

In addition, in order to improve data security, in some examples, a method through which the key generated by the server for the encryption dedicated FPGA is forwarded by the encryption dedicated FPGA accelerator includes:

the key generated by the server for the encryption dedicated FPGA accelerator is transmitted, by the encryption dedicated FPGA accelerator through an inter-core data transmission channel, to the computation dedicated FPGA accelerator interconnected to the encryption dedicated FPGA accelerator; and the received key is forwarded, by the computation dedicated FPGA accelerator interconnected to the encryption dedicated FPGA accelerator, to other computation dedicated FPGA accelerators in a same router.

In the example, the first-level key chain is transmitted by an inter-core high-speed data transmission channel or transmitted from ends to ends between computation dedicated FPGA accelerators in the same router in the interconnected FPGA accelerator cluster. The router is not required for search and forwarding in the whole process. Thus, a transmission rate is rapid, it is difficult to detect transmission by a malicious program dedicated to router communication, and data security can be effectively improved.

A key chain (hereinafter referred to as a third-level key chain) is generated by the encryption dedicated FPGA accelerator while the two-level key chain is generated by the server. Third-level key chain

$$< {S}_{3 , {n}_{3}}^{i} >$$

is generated by the encryption dedicated FPGA accelerator by using pseudorandom function Sⁱ3. A time interval of updating the third-level key chain is marked as Δ3, and n₃ keys exist in total.

Encryption authentication is performed on the to-be-transmitted data by using the three-level key chain such that a decryption difficulty can be improved and security of data transmission can be ensured.

Adapted to the first initial key including the first-level initial key and a second-level initial key, the first verification key includes: a first-level verification key and a second-level verification key. A first-level verification key is computed by the server according to the first-level initial key. A second-level verification key is computed by the server according to the second-level initial key.

In this case, when data is transmitted by the server, time serial numbers j₁, j₂ and j₃ corresponding to current time is first computed by the server according to

$${j}_{m} = \frac{{T}_{now} - {T}_{0}}{Δ m} mod {n}_{m}$$

and m=1,2,3. Specifically, j₁ is a time serial number of a first-level key chain, j₂ is a time serial number of a second-level key chain, and j₃ is a time serial number of a third-level key chain.

$${j}_{1} = \frac{{T}_{now} - {T}_{0}}{Δ 1} mod {n}_{1} ;$$

$${j}_{2} = \frac{{T}_{now} - {T}_{0}}{Δ 2} mod {n}_{2} ;$$

$${j}_{3} = \frac{{T}_{now} - {T}_{0}}{Δ 3} mod {n}_{3} .$$

Then, keys

$${S}_{1 , {j}_{1}}^{i} , {S}_{2 , {j}_{2}} , and {S}_{3 , {j}_{3}}^{i}$$

corresponding to the current time are computed by the server according to the time serial numbers, initial keys Sⁱ_{1,0}, S_{2,0} and Sⁱ_{3,0},

$${S}_{m , {j}_{m}}^{i} = {S}_{m}^{i {j}_{m}} ( {S}_{m , 0}^{i} ) , m = 1 , 3 , m = 1 , 3 , {S}_{m , {j}_{m}} = {S}_{m}^{{j}_{m}} ( {s}_{m , 0} ) , m = 2 , and m = 2 .$$

$${S}_{1 , {j}_{1}}^{i} = {S}_{1}^{i , {j}_{1}} ( {S}_{1 , 0}^{i} ) ;$$

$${S}_{2 , {j}_{2}}^{i} = {S}_{2}^{{j}_{2}} ( {S}_{2 , 0}^{i} ) ;$$

$${S}_{3 , {j}_{3}}^{i} = {S}_{3}^{i , {j}_{3}} ( {S}_{3 , 0}^{i} ) .$$

Based on that the keys are computed, data message Pkg is generated by the server according to the keys, the to-be-transmitted data, and

$$Pkg = MAC ( data , {S}_{1 , 0}^{j} , {S}_{1 , 0}^{j} , {S}_{1 , 0}^{j} ) .$$

and transmitted to a corresponding computation dedicated FPGA accelerator.

When the data message is generated and transmitted by the server, the following operations are performed by the server in parallel: encryption dedicated server i is requested for key

$${S}_{3 , {j}_{3}}^{i}$$

corresponding to time serial number j₃, that is, a second verification key; and verification data message Chk_pkg including

$${S}_{3 , {j}_{3}}^{i} ,$$

first-level verification key

$${S}_{1 , {j}_{1}}^{i}$$

obtained number by searching the server itself, and second-level verification key S_{2,j}_{₂} is transmitted to a corresponding computation dedicated FPGA accelerator.

After the data message and the verification data message are received by the computation dedicated FPGA accelerator, the verification data message is first parsed, and

$${S}_{1 , {j}_{1}}^{i} , {S}_{2 , {j}_{2}} , and {S}_{3 , {j}_{3}}^{i}$$

are obtained. Then, to-be-verified keys

$${S}_{1 , {j}_{1}}^{i} , {S}_{2 , {j}_{2}} and {S}_{3 , {j}_{3}}^{i}$$

are computed by the computation dedicated FPGA accelerator according to the initial keys. The computed to-be-verified keys are compared with verification keys obtained through parsing. If a comparison result shows that the keys are the same, network security passes verification. On the contrary, if a comparison result shows that the keys are different, network security does not pass verification. In a case that the network security does not pass the verification, the data message is not received by the computation dedicated FPGA accelerator. In a case that the network security passes the verification, the validity of the data message is verified by the computation dedicated FPGA accelerator by further using verification keys

$${S}_{1 , {j}_{1}}^{i} , {S}_{2 , {j}_{2}} , and {S}_{3 , {j}_{3}}^{i}$$

obtained through parsing. If the network security passes the verification, the data message is received. Otherwise, the data message is not received.

Further, based on the above examples, as a particular embodiment, a time interval for updating a second-level key chain by the server is greater than a time interval for updating a first-level key chain by the server and less than a time interval for updating a key chain by the encryption dedicated FPGA accelerator. The first-level key chain is a key chain generated by the server for the encryption dedicated FPGA accelerator. The second-level key chain is a key chain generated by the server for the computation dedicated FPGA accelerator.

The time interval for updating the first-level key chain by the server, the time interval for updating the second-level key chain by the server, and the time interval for updating the key chain by the encryption dedicated FPGA accelerator specifically may satisfy:

$$Δ2 = {n}_{{1}^{⋆}} Δ1 ; \\ and \\ Δ3 = {n}_{{2}^{⋆}} Δ2 .$$

Specifically, Δ1 denotes the time interval for updating the first-level key chain by the server, n₁ denotes a number of keys in the first-level key chain, Δ2 denotes the time interval for updating the second-level key chain by the server, n₂ denotes a number of keys in the second-level key chain, and Δ3 denotes the time interval for updating the key chain by the encryption dedicated FPGA accelerator.

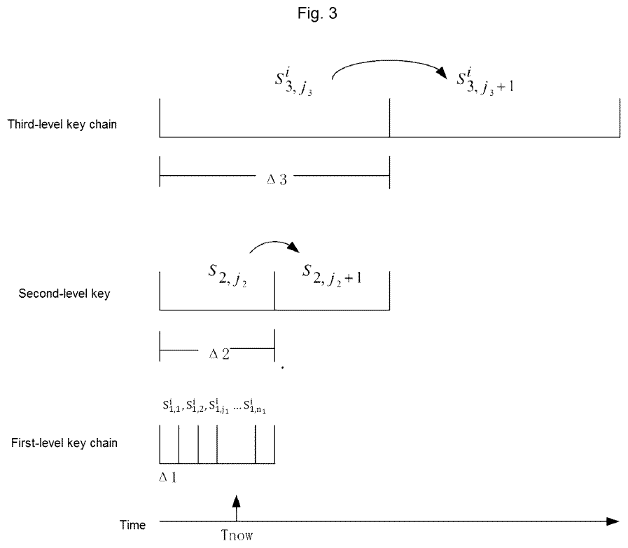

With reference to FIG. 3, in the example, the time interval for updating the first-level key chain by the server is Δ1, the time interval for updating the second-level key chain by the server is Δ2=Δ1*n₁, and the time interval for updating the third-level key chain by the encryption dedicated FPGA accelerator is Δ3=Δ2*n₂.

Since the second-level key chain is distributed by the server for the computation dedicated FPGA accelerator, a number of times of distribution of a router in the FPGA accelerator cluster network is more, and more bandwidths are occupied. Thus, in the example, time granularity for updating the second-level key chain is coarser than that of the first-level key chain. A main function of the third-level key chain is to resolve the problem that the first-level key chain and the second-level key chain are not trusted due to a security risk of the server. In the example, the time interval for updating the third-level key chain by the encryption dedicated FPGA accelerator is set as Δ3=Δ2*n₂. In a normal network environment, the difficulty of decrypting the key chain will be further improved by introducing the third-level key chain. Thus, security of data communication of the FPGA accelerator cluster network is ensured.

In a case that the message transmitter is a computation dedicated FPGA accelerator, that is, in a case that an execution object of a communication method is a computation dedicated FPGA accelerator, a method through which the message is transmitted by the computation dedicated FPGA accelerator is as follows:

a key corresponding to current time is computed by the computation dedicated FPGA accelerator according to initial keys, where the initial keys include at least one first initial key and a second initial key, the first initial key is generated by a server, and the second initial key is generated by an encryption dedicated FPGA accelerator; a data message is generated by the computation dedicated FPGA accelerator according to the keys and the to-be-transmitted data and transmitted to a corresponding computation dedicated FPGA accelerator or server; a verification data message is generated by the computation dedicated FPGA accelerator according to verification keys, where the verification keys include at last one first verification key and a second verification key, the first verification key is obtained by searching the server itself, and the second verification key is obtained by searching the encryption dedicated FPGA accelerator; and the verification data message is transmitted by the computation dedicated FPGA accelerator to the corresponding computation dedicated FPGA accelerator or server, and validity of the data message is caused to be verified by the computation dedicated FPGA accelerator or the server according to the initial keys and the verification data message.

Specifically, when a message is transmitted by the computation dedicated FPGA accelerator, on the one hand, a key corresponding to the current time is computed by the computation dedicated FPGA accelerator according to the initial keys. The initial keys include at least one first initial key generated by the server and a second initial key generated by the encryption dedicated FPGA accelerator. Thus, the key corresponding to the current time is computed by the computation dedicated FPGA accelerator according to the first initial key generated by the server. The key corresponding to the current time is computed according to the second initial key generated by the encryption dedicated FPGA accelerator.

A time serial number corresponding to the current time is computed by the computation dedicated FPGA accelerator according to the current time, initial time, and a time interval for updating a key chain. The key corresponding to the current time is computed according to the time serial number and the initial keys.

A relationship among the current time, the initial time, the time interval for updating the key chain, and the time serial number may be as follows:

$$j = \frac{{T}_{now} - {T}_{0}}{Δ} mod n ;$$

Specifically, j denotes the time serial number, T_{now} denotes the current time, T₀ denotes the initial time, Δ denotes the time interval for updating the key chain, and n denotes a number of keys in the key chain.

A relationship among the time serial number, the initial keys, and the key corresponding to the current time may be as follows:

Sⱼ=S^{j}(S₀). Specifically, Sⱼ denotes the key corresponding to the current time, and S₀ denotes the initial keys.

Based on that each key is computed, a data message is formed from the to-be-transmitted data and the key by the computation dedicated FPGA accelerator by using a message authentication code (MAC) function, and is transmitted to a corresponding computation dedicated FPGA accelerator or server.

On the other hand, the computation dedicated FPGA accelerator searches the server for the first verification key corresponding to the time serial number, and searches the encryption dedicated FPGA accelerator for the second verification key corresponding to the time serial number. The found first verification key and second to-be-verified key are combined into a verification data message. The verification data message is transmitted to a corresponding computation dedicated FPGA accelerator or server. Validity of the data message is verified by the computation dedicated FPGA accelerator or the server according to the initial keys which are received and verification data message which are generated by the server and the encryption dedicated FPGA accelerator.

The data message and the verification data message may be transmitted to a message receiving end in parallel. In a case that the message transmitter is a computation dedicated FPGA accelerator, the data message and the verification data message are transmitted by the computation dedicated FPGA accelerator to a corresponding computation dedicated FPGA accelerator or server in parallel. Thus, efficiency and security of data authentication can be effectively improved.

In addition, a step that the validity of the data message is verified according to the initial keys and the verification data message may include:
the verification data message is parsed, and the verification keys are obtained;
to-be-verified keys are computed according to the initial keys;
the verification keys are compared with the to-be-verified keys;
the data message is not received in a case that the verification keys are different from the to-be-verified keys;
the validity of the data message is verified according to the verification keys in a case that the verification key are the same as the to-be-verified keys;
the data message is received in a case that the validity passes verification; and
the data message is not received in a case that the validity does not pass the verification.

For instance, the message receiver is a server, after the data message and verification data message transmitted by the server are received by the server, the verification data message is first parsed, and the verification keys are obtained. Then, to-be-verified keys are computed by the server according to the initial keys. The computed verification keys are compared with the to-be-verified keys obtained through parsing. If a comparison result shows that the keys are the same, network security passes verification. On the contrary, if the comparison result shows that the keys are different, the network security does not pass the verification. Network security of the server has a hidden danger. In a case that the network security does not pass the verification, the data message is not received by the server. In a case that the network security passes the verification, the validity of the data message is verified, that is, whether data in the data message is normal is verified by the server by further using the verification keys obtained through parsing. If the network security passes the verification, it represents that normal data can be obtained, and the data message is received by the server. Otherwise, the data message is not received by the server.

To further enhance security of data communication and reduce a difficulty of decrypting a single key chain, in some examples, a two-level key chain is generated by the server. A first-level key chain is a key chain generated by the server for each encryption dedicated FPGA accelerator and an interconnected FPGA accelerator cluster corresponding to the encryption dedicated FPGA accelerator. Thus, data encryption authentication for each encryption dedicated FPGA accelerator and an interconnected FPGA accelerator cluster corresponding to the encryption dedicated FPGA accelerator can be implemented. Since a number of encryption dedicated FPGA accelerators in the FPGA accelerator cluster network is much less than that of computation dedicated FPGA accelerators, fewer network resources such as a bandwidth are occupied when the generated key chain is transmitted by the server for each encryption dedicated FPGA accelerator.

A second-level key chain is a key chain generated by the server for the computation dedicated FPGA accelerator and is used for supplementary authentication when data is forwarded by the computation dedicated FPGA accelerator. Since the second-level key chain is distributed by the server for the computation dedicated FPGA accelerator, a number of times of distribution of a router in the FPGA accelerator cluster network is more, and more bandwidths are occupied.

Specifically, first-level key chain

$$〈 {S}_{1 , {n}_{1}}^{i} 〉$$

is generated by the server by using pseudorandom function Sⁱ₁. First-level key chain

$$〈 {S}_{1 , {n}_{1}}^{i} 〉$$

is distributed to an encryption dedicated FPGA accelerator (a serial number of the encryption dedicated FPGA accelerator is i). A time interval for updating the first-level key chain is marked as Δ1, and n₁ keys exist in total.

The received first-level key chain is distributed by encryption dedicated FPGA accelerator i to a computation dedicated FPGA accelerators in a corresponding interconnected FPGA accelerator cluster.

Second-level key chain <S_{2,n}_{₂} > is generated by the server by using pseudorandom function S₂. Second-level key chain <S_{2,n}_{₂} > is distributed in a broadcast manner to the computation dedicated FPGA accelerator in the FPGA accelerator cluster network. A time interval for updating the second-level key chain is marked as Δ2, and n₂ keys exist in total.

By generating a key by using the first-level key chain and the second-level key chain cooperatively, security of data communication can be further improved.

In order to improve data security, in some examples, different key chains are generated for different encryption dedicated FPGA accelerators by the server by using different pseudorandom functions.

In addition, in order to improve data security, in some examples, a method through which the key generated by the server for the encryption dedicated FPGA is forwarded by the encryption dedicated FPGA accelerator includes:

the key generated by the server for the encryption dedicated FPGA accelerator is transmitted, by the encryption dedicated FPGA accelerator through an inter-core data transmission channel, to the computation dedicated FPGA accelerator interconnected to the encryption dedicated FPGA accelerator; and the received key is forwarded, by the computation dedicated FPGA accelerator interconnected to the encryption dedicated FPGA accelerator, to other computation dedicated FPGA accelerators in a same router.

In the example, the first-level key chain is transmitted by an inter-core high-speed data transmission channel or transmitted from ends to ends between computation dedicated FPGA accelerators in the same router in the interconnected FPGA accelerator cluster. The router is not required for search and forwarding in the whole process. Thus, a transmission rate is rapid, it is difficult to detect transmission by a malicious program dedicated to router communication, and data security can be effectively improved.

A key chain (hereinafter referred to as a third-level key chain) is generated by the encryption dedicated FPGA accelerator while the two-level key chain is generated by the server. Third-level key chain

$$〈 {S}_{3 , {n}_{3}}^{i} 〉$$

is generated by une encryption dedicated FPGA accelerator by using pseudorandom function

$${S}_{3}^{i} .$$

A time interval of updating third-level key chain is marked as Δ3, and n₃ keys exist in total.

Encryption authentication is performed on the to-be-transmitted data by using the three-level key chain such that a decryption difficulty can be improved and security of data transmission can be ensured.

Adapted to the first initial key including the first-level initial key and a second-level initial key, the first verification key includes: a first-level verification key and a second-level verification key. A first-level verification key is computed by the server according to the first-level initial key. A second-level verification key is computed by the server according to the second-level initial key.

In this case, when data is transmitted by the computation dedicated FPGA accelerator, time serial numbers j₁, j₂, and j₃ corresponding to current time are first computed by the computation dedicated FPGA accelerator according to

$${j}_{m} = \frac{{T}_{n o w} - {T}_{0}}{Δ m} mod {n}_{m}$$

and m=1,2,3. Specifically, j₁ is a time serial number of a first-level key chain, j₂ is a time serial number of a second-level key chain, and j₃ is a time serial number of a third-level key chain.

$${j}_{1} = \frac{{T}_{n o w} - {T}_{0}}{Δ1} mod {n}_{1} ; \\ {j}_{2} = \frac{{T}_{n o w} - {T}_{0}}{Δ2} mod {n}_{2 ;} \\ {j}_{3} = \frac{{T}_{n o w} - {T}_{0}}{Δ3} mod {n}_{3} .$$

Keys

$${S}_{1 , 0}^{i} , {S}_{2 , 0} and {S}_{3 , 0}^{i}$$

corresponding to the current time are computed by the computation dedicated FPGA accelerator according to the time serial numbers, initial keys Sⁱ_{1,0}, S_{2,0} and

$${S}_{3 , 0}^{i} , {S}_{m , {j}_{m}}^{i} = {S}_{m}^{{ij}_{m}} ( {S}_{m , 0}^{i} ) , m = 1 , 3 , and$$

$${S}_{m , {j}_{m}} = {S}_{m}^{{j}_{m}} ( {S}_{m , 0} ) , m = 2 , and m = 2 .$$

$${S}_{1 , {j}_{1}}^{i} = {S}_{1}^{{ij}_{1}} ( {S}_{1 , 0}^{i} ) ; \\ {S}_{2 , {j}_{2}} = {S}_{2}^{{j}_{2}} ( {S}_{2 , 0} ) ; \\ {S}_{3 , {j}_{3}}^{i} = {S}_{3}^{{ij}_{3}} ( {S}_{3 , 0}^{i} ) ∘$$

Based on that the keys are computed, data message Pkg is generated by the computation dedicated FPGA accelerator according to the keys, the to-be-transmitted data, and

$$Pkg = MAC ( data , {S}_{1 , {j}_{1}}^{i} , {S}_{2 , {j}_{2}} , {S}_{3 , {j}_{3}}^{i} ) ,$$

and transmitted to a corresponding computation dedicated FPGA accelerator or server.

When the data message is generated and transmitted by the computation dedicated FPGA accelerator, the following operations are performed by the computation dedicated FPGA accelerator in parallel: encryption dedicated server i is requested for key S_{3,j}_{₃}ⁱ corresponding to time serial number j₃, that is, a second verification key; and verification data message Chk_pkg including

$${S}_{3 , {j}_{3}}^{i}$$

first-level verification key

$${S}_{1 , {j}_{1}}^{i}$$

obtained by searching the server, and second-level verification key S_{2,j}_{₂} is transmitted to a corresponding computation dedicated FPGA accelerator or server.

After the data message and the verification data message are received by the computation dedicated FPGA accelerator or the server, the verification data message is first parsed, and verification keys

$${S}_{1 , {j}_{1}}^{i} , {S}_{2 , {j}_{2}} , and {S}_{3 , {j}_{3}}^{i}$$

are obtained. Then, to-be-verified keys

$${S}_{1 , {j}_{1}}^{i} , {S}_{2 , {j}_{2}} , and {S}_{3 , {j}_{3}}^{i}$$

according to the initial keys. The computed to-be-verified keys are compared with verification keys obtained through parsing. If a comparison result shows that the keys are the same, network security passes verification. On the contrary, if a comparison result shows that the keys are different, network security does not pass verification. In a case that the network security does not pass the verification, the data message is not received by the computation dedicated FPGA accelerator. In a case that the network security passes the verification, the validity of the data message is verified by the computation dedicated FPGA accelerator by further using verification keys

$${S}_{1 , {j}_{1}}^{i} , {S}_{2 , {j}_{2}} , and {S}_{3 , {j}_{3}}^{i}$$

obtained through parsing. If the network security passes the verification, the data message is received. Otherwise, the data message is not received.

Further, the time interval for updating the first-level key chain by the server, the time interval for updating the second-level key chain by the server, and the time interval for updating the key chain by the encryption dedicated FPGA accelerator specifically may satisfy:

$$Δ2 = {n}_{1} * Δ1 ; \\ and \\ Δ3 = {n}_{2} * Δ2 .$$

Specifically, Δ1 denotes the time interval for updating the first-level key chain by the server, n₁ denotes a number of keys in the first-level key chain, Δ2 denotes the time interval for updating the second-level key chain by the server, n₂ denotes a number of keys in the second-level key chain, and Δ3 denotes the time interval for updating the key chain by the encryption dedicated FPGA accelerator.

With reference to FIG. 3, in the example, the time interval for updating the first-level key chain by the server is Δ1, the time interval for updating the second-level key chain by the server is Δ2=Δ1*n₁, and the time interval for updating the third-level key chain by the encryption dedicated FPGA accelerator is Δ3=Δ2*n₂.

Since the second-level key chain is distributed by the server for the computation dedicated FPGA accelerator, a number of times of distribution of a router in the FPGA accelerator cluster network is more, and more bandwidths are occupied. Thus, in the example, time granularity for updating the second-level key chain is coarser than that of the first-level key chain. A main function of the third-level key chain is to resolve the problem that the first-level key chain and the second-level key chain are not trusted due to a security risk of the server. In the example, the time interval for updating the third-level key chain by the encryption dedicated FPGA accelerator is set as Δ3=Δ2*n₂. In a normal network environment, the difficulty of decrypting the key chain will be further improved by introducing the third-level key chain. Thus, security of data communication of the FPGA accelerator cluster network is ensured.

A communication example will be stated below in combination with a server, a computation dedicated FPGA accelerator, and an encryption dedicated FPGA accelerator.

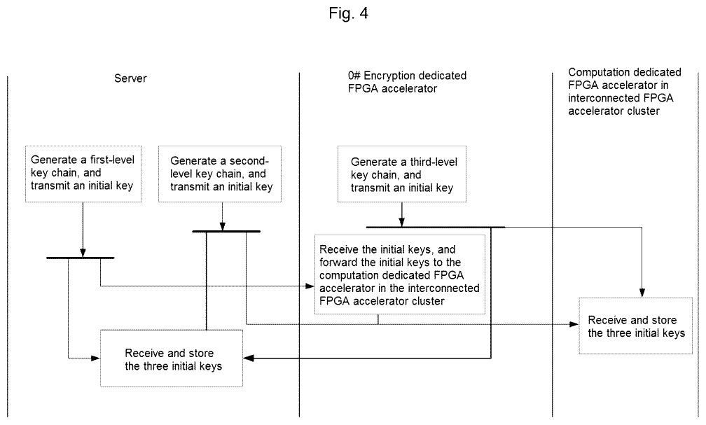

With refernce to a schemetic diagram of initialization confifuration of FIG. 4, during the initilization configuration, first-level key chain

$$〈 {S}_{1 , {n}_{1}}^{i} 〉$$

is generated by the server, and initial key

$${S}_{1 , 0}^{0}$$

is transmitted. Second-level key chain

$$〈 {S}_{2 , {n}_{2}} 〉$$

is generated by the server and initial key S_{2,0} is transmitted. A third-level key chain is generated by the encryption dedicated FPGA accelerator having a serial number of 0, and initial key

$${S}_{3 , 0}^{0}$$

is transmitted. Initial keys

$${S}_{1 , 0}^{0} , {S}_{2 , 0} , and {S}_{3 , 0}^{0}$$

are received and stored by the server. Initial key

$${S}_{1 , 0}^{0}$$

is received by the encryption dedicated FPGA accelerator having a serial number of 0 and is forwarded to a computation dedicated FPGA accelerator in a corresponding interconnected FPGA accelerator cluster. Initial keys

$${S}_{1 , 0}^{0} , {S}_{2 , 0} , and {S}_{3 , 0}^{0}$$

are received and stored by the computation dedicated FPGA accelerator in the interconnected FPGA accelerator cluster.

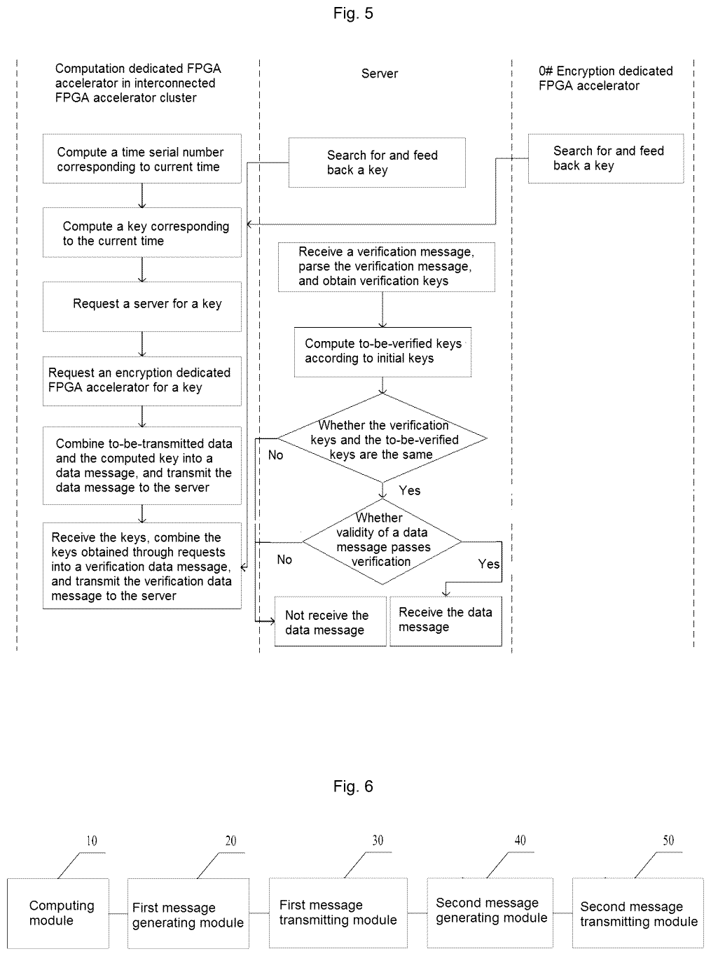

With reference to FIG. 5, time serial numbers j₁, j₂, and j₃ corresponding to data message transmission time, that is, current time T_{now} are computed by the computation dedicated FPGA accelerator in the interconnected FPGA accelerator cluster. Keys

$${S}_{1 , {j}_{1}}^{0} , {S}_{2 , {j}_{2}} and {S}_{3 , {j}_{3}}^{0}$$

corresponding to the current time are computed in combination with iniual keys

$${S}_{1 , 0}^{0} , {S}_{2 , 0} , and {S}_{3 , 0}^{0} .$$

A data message is generated by combining the to-be-transmitted data and keys

$${S}_{1 , {j}_{1}}^{0} , {S}_{2 , {j}_{2}} and {S}_{3 , {j}_{3}}^{0} ,$$

any transmitted to the server.

In addition, the computation dedicated FPGA accelerator in the interconnected FPGA accelerator cluster requests the encryption dedicated FPGA accelerator having a serial number of 0 for key

$${S}_{3 , {j}_{3}}^{0}$$

or time serial number j₃, and requests the server for keys

$${S}_{1 , {j}_{1}}^{0} and {S}_{2 , {j}_{2}}$$

of time serial numbers j₁ and j₂. A verification data message is generated by combining

$${S}_{1 , {j}_{1}}^{0} , {S}_{2 , {j}_{2}} and {S}_{3 , {j}_{3}}^{0}$$

verification keys obtained through requests, and is transmitted to the server.

After the data message and the verification data message are received by the server, the verification data message is first parsed, and verification keys

$${S}_{1 , {j}_{1}}^{0} , {S}_{2 , {j}_{2}} and {S}_{3 , {j}_{3}}^{0}$$

are obtained. In addition, to-be-verified keys

$${S}_{1 , {j}_{1}}^{0} , {S}_{2 , {j}_{2}} and {S}_{3 , {j}_{3}}^{0} .$$

are computed by the server according to initial keys

$${S}_{1 , 0}^{0} , {S}_{2 , 0} , and {S}_{3 , 0}^{0} .$$

The verification keys are compared with the to-be-verified keys. If the keys are different, the data message is not received. If the keys are the same, validity of the data message is verified by using verification keys

$${S}_{1 , {j}_{1}}^{0} , {S}_{2 , {j}_{2}} and {S}_{3 , {j}_{3}}^{0} .$$

If the network security passes the verification, the data message is received. If the network security does not pass the verification, the data message is not received.

It is assumed that Δl=10 ms, n₁=100, Δ2=1 s, n₂=60, Δ3=1min, and n₃=60. The three-level key chain provided in the example has an effective time length of 1 hour. If only a key chain generated by the encryption dedicated FPGA accelerator is used as a single-level authentication key chain, the single-level authentication key chain has an effective time length of 1 s. It can be seen that security efficiency of the solution provided in the example is increased by 3600 times.

To sum up, in the communication method provided in the disclosure, a key is generated by a server having a complex architecture and high security coefficient and an encryption dedicated FPGA accelerator dedicated to key generation. The key is generated by the server and the encryption dedicated FPGA accelerator which have strong security. Thus, network security can be effectively guaranteed, and a situation that the key is decrypted due to data leakage of the server can be avoided. In addition, the communication method provided in the disclosure is applicable to various network data forwarding scenarios such as broadcast, multicast, and unicast, and can be used for bidirectional data communication between a server and a computation dedicated FPGA accelerator. In a case that a message transmitter is a server, security of message transmission can be guaranteed by means of a complete security system of the server. In cases that a message transmitter is a computation dedicated

FPGA accelerator and message receivers are a server having a complete security system and other computation dedicated FPGA accelerators in an interconnected FPGA accelerator cluster, no router is required to participate in data forwarding with the other computation dedicated FPGA accelerators in the interconnected FPGA accelerator cluster. Point-to-point communication can be directly implemented. A security performance can be guaranteed.

The disclosure further provides a communication apparatus. The apparatus described below and the method described above can be obtained with reference to each other correspondingly. With regard to FIG. 6, a schematic diagram of a communication apparatus according to an example of the disclosure is shown in FIG. 6. As shown in FIG. 6, the apparatus includes:
a computing module 10 configured to compute a key corresponding to current time according to initial keys, where the initial keys include at least one first initial key and a second initial key, the first initial key is generated by a server, and the second initial key is generated by an encryption dedicated FPGA accelerator;
a first message generating module 20 configured to generate a data message according to the key and to-be-transmitted data;
a first message transmitting module 30 configured to transmit the data message to a message receiving end;
a second message generating module 40 configured to generate a verification data message according to verification keys, where the verification keys include at last one first verification key and a second verification key, the first verification key is obtained by searching the server, and the second verification key is obtained by searching the encryption dedicated FPGA accelerator; and
a second message transmitting module 50 configured to transmit the verification data message to the message receiving end, and cause validity of the data message to be verified by the message receiving end according to the initial keys and the verification data message.

Based on the above examples, as a particular embodiment, the first initial key includes: a first-level initial key and a second-level initial key. The first-level initial key is generated by the server for the encryption dedicated FPGA accelerator and forwarded by the encryption dedicated FPGA accelerator to a computation dedicated FPGA accelerator in an interconnected FPGA accelerator cluster corresponding to the encryption dedicated FPGA accelerator. The second-level initial key is generated by the server for the computation dedicated FPGA accelerator and broadcasted to the computation dedicated FPGA accelerator.

Based on the above examples, as a particular embodiment, a method through which the key generated by the server for the encryption dedicated FPGA is forwarded by the encryption dedicated FPGA accelerator includes:
the key generated by the server for the encryption dedicated FPGA accelerator is transmitted, by the encryption dedicated FPGA accelerator through an inter-core data transmission channel, to the computation dedicated FPGA accelerator interconnected to the encryption dedicated FPGA accelerator; and the received key is forwarded, by the computation dedicated FPGA accelerator interconnected to the encryption dedicated FPGA accelerator, to other computation dedicated FPGA accelerators in a same router.

Based on the above examples, as a particular embodiment, keys generated by the server for different encryption dedicated FPGA accelerators are different.

Based on the above examples, as a particular embodiment, the first verification key includes: a first-level verification key and a second-level verification key. A first-level verification key is computed by the server according to the first-level initial key. A second-level verification key is computed by the server according to the second-level initial key.

Based on the above examples, as a particular embodiment, the data message and the verification data message are transmitted to the message receiving end in parallel.

Based on the above examples, as a particular embodiment, the validity of the data message is caused to be verified according to the initial keys and the verification data message as follows:
the verification data message is parsed, and the verification keys are obtained;
to-be-verified keys are computed according to the initial keys;
the verification keys are compared with the to-be-verified keys;
the data message is not received in a case that the verification keys are different from the to-be-verified keys;
the validity of the data message is verified according to the verification keys in a case
that the verification keys are the same as the to-be-verified keys;
the data message is received in a case that the validity passes verification; and the data message is not received in a case that the validity does not pass the verification.

Based on the above examples, as a particular embodiment, a time interval for updating a second-level key chain by the server is greater than a time interval for updating a first-level key chain by the server and less than a time interval for updating a key chain by the encryption dedicated FPGA accelerator. The first-level key chain is a key chain generated by the server for the encryption dedicated FPGA accelerator. The second-level key chain is a key chain generated by the server for the computation dedicated FPGA accelerator.

Based on the above examples, as a particular embodiment, the time interval for updating the first-level key chain by the server, the time interval for updating the second-level key chain by the server, and the time interval for updating the key chain by the encryption dedicated FPGA accelerator satisfy:

$$Δ2 = {n}_{1} * Δ1 ; and \\ Δ3 = {n}_{2} * Δ2 .$$

Specifically, Δ1 denotes the time interval for updating the first-level key chain by the server, n₁ denotes a number of keys in the first-level key chain, Δ2 denotes the time interval for updating the second-level key chain by the server, n₂ denotes a number of keys in the second-level key chain, and Δ3 denotes the time interval for updating the key chain by the encryption dedicated FPGA accelerator.

Based on the above examples, as a particular embodiment, the computing module 10 includes:
a time serial number computing unit configured to compute a time serial number corresponding to the current time according to the current time, initial time, and a time interval for updating a key chain; and
a key computing unit configured to compute a key corresponding to the current time according to the time serial number and the initial keys.

Based on the above examples, as a particular embodiment, the time serial number computing unit is specifically configured to:
compute the time serial number corresponding to the current time according to

$$j = \frac{{T}_{now} - {T}_{0}}{Δ} mod n .$$

Specifically, j denotes the time serial number, T_{now} denotes the current time, T₀ denotes the initial time, Δ denotes the time interval for updating the key chain, and n denotes a number of keys in the key chain.

Based on the above examples, as a particular embodiment, the key computing unit is specifically configured to:
compute the key corresponding to the current time according to Sⱼ=S^{j}(S₀).

Specifically, Sⱼ denotes the key corresponding to the current time, j denotes the time serial number, and S₀ denotes the initial keys.

In the communication apparatus provided in the disclosure, a key is generated by a server having a complex architecture and high security coefficient and an encryption dedicated FPGA accelerator dedicated to key generation. The key is generated by the server and the encryption dedicated FPGA accelerator which have strong security. Thus, network security can be effectively guaranteed, and a situation that the key is decrypted due to data leakage of the server can be avoided. In addition, the communication method provided in the disclosure is applicable to various network data forwarding scenarios such as broadcast, multicast, and unicast, and can be used for bidirectional data communication between a server and a computation dedicated FPGA accelerator. In a case that a message transmitter is a server, security of message transmission can be guaranteed by means of a complete security system of the server. In cases that a message transmitter is a computation dedicated FPGA accelerator and message receivers are a server having a complete security system and other computation dedicated FPGA accelerators in an interconnected FPGA accelerator cluster, no router is required to participate in data forwarding with the other computation dedicated FPGA accelerators in the interconnected FPGA accelerator cluster. Point-to-point communication can be directly implemented. A security performance can be guaranteed.

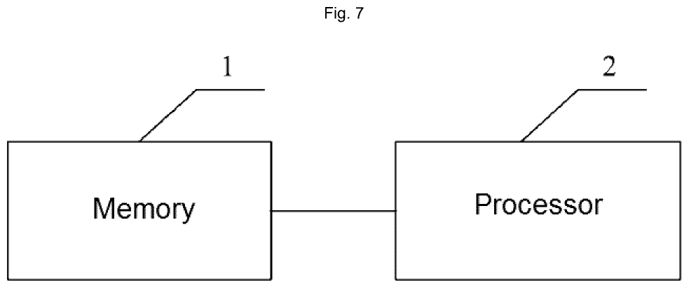

The disclosure further provides a communication device. As shown in FIG. 7, the device includes a memory 1 and a processor 2.

The memory 1 is configured to store a computer program.

The processor 2 is configured to implement the following steps when executing the computer program:
a key corresponding to current time is computed according to initial keys, where the initial keys include at least one first initial key and a second initial key, the first initial key is generated by a server, and the second initial key is generated by an encryption dedicated FPGA accelerator; a data message is generated according to the key and to-be-transmitted data; the data message is transmitted to a message receiving end; a verification data message is generated according to verification keys, where the verification keys include at last one first verification key and a second verification key, the first verification key is obtained by searching the server, and the second verification key is obtained by searching the encryption dedicated FPGA accelerator; and the verification data message is transmitted to the message receiving end, and validity of the data message is caused to be verified by the message receiving end according to the initial keys and the verification data message.

An introduction to the device provided in the disclosure can be obtained with reference to the above method examples and will not be repeated herein.

The disclosure further provides a non-volatile readable storage medium. The non-volatile readable storage medium stores a computer program. When executed by a processor, the computer program implements steps as follows:
a key corresponding to current time is computed according to initial keys, where the initial keys include at least one first initial key and a second initial key, the first initial key is generated by a server, and the second initial key is generated by an encryption dedicated FPGA accelerator; a data message is generated according to the key and to-be-transmitted data; the data message is transmitted to a message receiving end; a verification data message is generated according to verification keys, where the verification keys include at last one first verification key and a second verification key, the first verification key is obtained by searching the server, and the second verification key is obtained by searching the encryption dedicated FPGA accelerator; and the verification data message is transmitted to the message receiving end, and validity of the data message is caused to be verified by the message receiving end according to the initial keys and the verification data message.

The non-volatile readable storage medium may include various media capable of storing program codes, such as a universal serial bus (USB) flash drive, a removable hard disk, a read-only memory (ROM), a random access memory (RAM), a magnetic disk, and an optical disk.

An introduction to the non-volatile readable storage medium provided in the disclosure can be obtained with reference to the above method examples and will not be repeated herein.

Each example of the description is described in a progressive manner. Each example focuses on the differences from other examples. Same and similar portions among the examples can be obtained with reference to one another. The apparatus, device, and non-volatile readable storage medium disclosed in examples correspond to a method disclosed in examples and thus are briefly described. Related portions can be obtained with reference to the descriptions of the method portion.

A person skilled in the art can further realize that units and algorithm steps in instances described in combination with examples disclosed herein can be implemented by electronic hardware, computer software, or their combination. In order to clearly illustrate interchangeability of hardware and software, components and steps in instances are generally described according to functions in the above descriptions. Whether these functions are performed by hardware or software depends on specific application and design constraints of the technical solutions. A person skilled in the art can implement described functions through different methods for each specific application, and such implementation should not be considered as falling beyond the scope of the disclosure.

Steps of a method or algorithm described in combination with examples disclosed herein may be directly implemented by hardware, a software module executed by a processor, or their combination. The software module may be placed in a random access memory (RAM), a memory, a read-only memory (ROM), an electrically programmable ROM, an electrically erasable programmable ROM, a register, a hard disk, a removable disk, a CD-ROM, or storage media in any other forms known in the technical field.

The communication method, apparatus, and device, and non-volatile readable storage medium provided in the disclosure are introduced in detail above. Principles and embodiments of the disclosure are stated by using particular instances herein. The descriptions of the above examples are merely used for assisting understanding of the method in the disclosure and its core concept. It should be noted that a person of ordinary skill in the art can make several improvements and modifications on the disclosure without departing from the principles of the disclosure. These improvements and modifications also fall within the scope of protection of claims of the disclosure.
computing a key corresponding to current time according to initial keys, wherein the initial keys comprise at last one first initial key and a second initial key, the at least one first initial key is generated by a server, and the second initial key is generated by an encryption dedicated field programmable gate array (FPGA) accelerator;
generating a data message according to the key and to-be-transmitted data;
transmitting the data message to a message receiving end;
generating a verification data message according to verification keys, wherein the verification keys comprise at last one first verification key and a second verification key, the at last one first verification key is obtained by searching the server, and the second verification key is obtained by searching the encryption dedicated FPGA accelerator; and
transmitting the verification data message to the message receiving end, and causing validity of the data message to be verified by the message receiving end according to the initial keys and the verification data message.

2. The communication method according to claim 1, wherein the at least one first initial key comprise: a first-level initial key and a second-level initial key; the first-level initial key is generated by the server for the encryption dedicated FPGA accelerator and forwarded by the encryption dedicated FPGA accelerator to a computation dedicated FPGA accelerator in an interconnected FPGA accelerator cluster corresponding to the encryption dedicated FPGA accelerator; and the second-level initial key is generated by the server for the computation dedicated FPGA accelerator and broadcasted to the computation dedicated FPGA accelerator.

3. The communication method according to claim 2, wherein a method through which the first-level initial key generated by the server for the encryption dedicated FPGA accelerator is forwarded by the encryption dedicated FPGA accelerator comprises:
transmitting, by the encryption dedicated FPGA accelerator through an inter-core data transmission channel, the first-level initial key generated by the server for the encryption dedicated FPGA accelerator to the computation dedicated FPGA accelerator interconnected to the encryption dedicated FPGA accelerator, and forwarding, by the computation dedicated FPGA accelerator interconnected to the encryption dedicated FPGA accelerator, the first-level initial key which is received to other computation dedicated FPGA accelerators in a same router.

4. The communication method according to claim 2, wherein keys generated by the server for different encryption dedicated FPGA accelerators are different.

5. The communication method according to claim 2, wherein the at last one first verification key comprise: a first-level verification key and a second-level verification key; a first-level verification key is computed by the server according to the first-level initial key; and a second-level verification key is computed by the server according to the second-level initial key.

6. The communication method according to claim 1, wherein the data message and the verification data message are transmitted to the message receiving end in parallel.

7. The communication method according to claim 1, wherein the validity of the data message is caused to be verified according to the initial keys and the verification data message as follows:
parsing the verification data message, and obtaining the verification keys;
computing to-be-verified keys according to the initial keys;
comparing the verification keys with the to-be-verified keys;
not receiving the data message in a case that the verification keys are different from the to-be-verified keys;
verifying the validity of the data message according to the verification keys in a case that the verification keys are the same as the to-be-verified keys;
receiving the data message in a case that the validity passes verification; and
not receiving the data message in a case that the validity does not pass the verification.

8. The communication method according to claim 1, wherein a time interval for updating a second-level key chain by the server is greater than a time interval for updating a first-level key chain by the server and less than a time interval for updating a key chain by the encryption dedicated FPGA accelerator; and the first-level key chain is a key chain generated by the server for the encryption dedicated FPGA accelerator, and the second-level key chain is a key chain generated by the server for the computation dedicated FPGA accelerator.

9. The communication method according to claim 8, wherein the time interval for updating the first-level key chain by the server, the time interval for updating the second-level key chain by the server, and the time interval for updating a key chain by the encryption dedicated FPGA accelerator satisfy:
$$Δ2 = {n}_{1} * Δ1 ; and \\ Δ3 = {n}_{2} * Δ2 ;$$
wherein
Δ1 denotes the time interval for updating the first-level key chain by the server, n₁ denotes a number of keys in the first-level key chain, Δ2 denotes the time interval for updating the second-level key chain by the server, n₂ denotes a number of keys in the second-level key chain, and Δ3 denotes the time interval for updating the key chain by the encryption dedicated FPGA accelerator.

10. The communication method according to claim 1, wherein computing the key corresponding to the current time according to the initial keys comprises:
computing a time serial number corresponding to the current time according to the current time, initial time, and a time interval for updating a key chain; and
computing the key corresponding to the current time according to the time serial number and the initial keys.

11. The communication method according to claim 10, wherein computing the time serial number corresponding to the current time according to the current time, the initial time, and the time interval for updating the key chain comprises:
computing the time serial number corresponding to the current time according to
$$j = \frac{{T}_{now} - {T}_{0}}{Δ} mod n ;$$
wherein
j denotes the time serial number, T_{now} denotes the current time, T₀ denotes the initial time, Δ denotes the time interval for updating the key chain, and n denotes a number of keys in the key chain.

12. The communication method according to claim 10, wherein the computing the key corresponding to the current time according to the time serial number and the initial keys comprises:
computing the key corresponding to the current time according to Sⱼ=S^{j}(S₀); wherein Sⱼ denotes the key corresponding to the current time, j denotes the time serial number, and S₀ denotes the initial keys.

13. The communication method according to claim 1, applied to an FPGA accelerator cluster network based on a tree topology, wherein the FPGA accelerator cluster network based on a tree topology mainly comprises the server, the encryption dedicated FPGA accelerator, a computation dedicated FPGA accelerator, and a router.

14. The communication method according to claim 1, wherein a key chain is generated by the encryption dedicated FPGA accelerator by using a pseudorandom function, and the key chain is used for being updated to the server and a computation dedicated FPGA accelerator in an interconnected FPGA accelerator cluster corresponding to the encryption dedicated FPGA accelerator.

15. The communication method according to claim 14, wherein a function of the computation dedicated FPGA accelerator comprises: generating and transmitting a message to a message receiver.

16. The communication method according to claim 15, wherein
in an FPGA accelerator cluster network, a message transmitter is a server, and the message receiver is a computation dedicated FPGA accelerator; or
in an FPGA accelerator cluster network, a message transmitter is a computation dedicated FPGA accelerator, and the message receiver is a computation dedicated FPGA accelerator or a server.

17. The communication method according to claim 16, wherein
in a case that the message transmitter is the server, the first verification key is a key computed by the server according to the at least one first initial key, and the second verification key is a key acquired by the server from the encryption dedicated FPGA accelerator and is a key corresponding to the current time computed by the encryption dedicated FPGA accelerator according to the second initial key; and
in a case that the message transmitter is the computation dedicated FPGA accelerator, the first verification key is a key acquired by the computation dedicated FPGA accelerator from the server and is a key corresponding to the current time computed by the server according to the at least one first initial key, and the second verification key is a key acquired by the computation dedicated FPGA accelerator from the encryption dedicated FPGA accelerator and is a key corresponding to the current time computed by the encryption dedicated FPGA accelerator according to the second initial key.

18. (canceled)

19. A communication device, comprising:
a memory configured to store a computer program; and
a processor configured to implement to:
compute a key corresponding to current time according to initial keys, wherein the initial keys comprise at last one first initial key and a second initial key, the at least one first initial key is generated by a server, and the second initial key is generated by an encryption dedicated field programmable gate array (FPGA) accelerator;
generate a data message according to the key and to-be-transmitted data;
transmit the data message to a message receiving end;
generate a verification data message according to verification keys, wherein the verification keys comprise at last one first verification key and a second verification key, the at last one first verification key is obtained by searching the server, and the second verification key is obtained by searching the encryption dedicated FPGA accelerator; and
transmit the verification data message to the message receiving end, and cause validity of the data message to be verified by the message receiving end according to the initial keys and the verification data message.

20. A non-volatile readable storage medium, storing a computer program, wherein the computer program, when executing the computer program, is configured to implement to:
compute a key corresponding to current time according to initial keys, wherein the initial keys comprise at last one first initial key and a second initial key, the at least one first initial key is generated by a server, and the second initial key is generated by an encryption dedicated field programmable gate array (FPGA) accelerator;
generate a data message according to the key and to-be-transmitted data;
transmit the data message to a message receiving end;
generate a verification data message according to verification keys, wherein the verification keys comprise at last one first verification key and a second verification key, the at last one first verification key is obtained by searching the server, and the second verification key is obtained by searching the encryption dedicated FPGA accelerator; and
transmit the verification data message to the message receiving end, and cause validity of the data message to be verified by the message receiving end according to the initial keys and the verification data message.

21. The communication method according to claim 13, wherein
in an initialization phase of the FPGA accelerator cluster network, each encryption dedicated FPGA accelerator is responsible for uploading information of the encryption dedicated FPGA accelerator and information of an interconnected FPGA accelerator cluster corresponding to the encryption dedicated FPGA accelerator to the server,
the information uploaded by the encryption dedicated FPGA accelerator is received and stored by the server, a key chain is generated by using a pseudorandom function.
